(19) United States
(12) Patent Application Publication
(10) Pub. No.: US 2026/0298843 A1
(43) Pub. Date: Oct. 1, 2026

(54) X-RAY INSPECTION DEVICE AND PREVENTIVE MAINTENANCE DEVICE THEREFOR

(71) Applicant: ANRITSU CORPORATION, Kanagawa (JP)

(72) Inventors: Tatsuki KOMATSUBARA, Kanagawa (JP); Takashi KANAI, Kanagawa (JP)

(21) Appl. No.: 19/568,981

(22) Filed: Mar. 17, 2026

(30) Foreign Application Priority Data
Mar. 27, 2025 (JP) 2025-053971

(51) Int. Cl. G01N 23/04

(52) U.S. Cl. CPC G01N 23/04; G01N 2223/1016; G01N 2223/401; G01N 2223/408; G01N 2223/643; G01N 2223/645; G01N 2223/652

(57) ABSTRACT

An X-ray inspection device includes an X-ray irradiation unit that irradiates a transported article with X-rays, an X-ray detector that outputs each of X-ray detection signals from an X-ray detection element group arranged in a direction orthogonal to a transport direction of the article, an inspection control unit that executes image processing for inspecting a quality state of the article based on the X-ray detection signals from the X-ray detection element group, a sensitivity correction data storage unit that stores alignment data during sensitivity correction which corresponds to the arrangement of the X-ray detection element group for each predetermined period, and deterioration sign detection means for comparing the stored data before and after a predetermined deterioration observation period to detect a sign of performance deterioration of the X-ray detector which affects the inspection.

### TECHNICAL FIELD

The present invention relates to an X-ray inspection device and a preventive maintenance device therefor, and particularly to an X-ray inspection device for inspecting an article and a preventive maintenance device for an X-ray inspection device that has a preventive maintenance function.

### BACKGROUND ART

An X-ray inspection device is widely used that inspects a quality state of an article, such as food, for example, whether or not a foreign matter is contained, a missing article, and other abnormalities. The X-ray inspection device irradiates the article that is being transported with X-rays, detects the transmitted X-rays using a scanning operation of an X-ray detector, such as an X-ray line sensor, to acquire image data, and determines the quality state of the article based on a result of performing predetermined image processing on the image data.

In this X-ray inspection device, in general, timely maintenance work is required since an expensive X-ray generator, such as an X-ray tube, is a consumable item and the X-ray detector undergoes performance deterioration due to repeated exposure to X-rays from the X-ray generator. Therefore, an hour meter or the like that measures the cumulative energization time is provided to improve the workability of the maintenance work.

As this type of X-ray inspection device according to the related art, for example, an X-ray inspection device is known in which X-ray irradiation conditions (a tube voltage and a tube current) and an irradiation time during an inspection operation are stored in a backup memory such that information related to the X-ray irradiation conditions and the irradiation time in the most recent inspection operation can be easily acquired during the maintenance work (for example, see Patent Document 1).

In addition, a technique is known that executes a diagnostic test on a detection level of an X-ray line sensor when an X-ray inspection device is started, stores and accumulates the diagnostic results such that a change in the detection level of the X-ray line sensor over time can be understood, and outputs a warning when the detection level falls below a predetermined lower limit value (for example, see Patent Document 2).

Further, a technique is known that detects X-rays which have not been transmitted through an inspection object using an X-ray detector, calculates a difference between an average value of X-ray image data based on X-ray detection signals from a plurality of X-ray detection elements and each pixel value of X-ray image data based on the X-ray detection signal of each X-ray detection element, and sets a correction value such that an output level of each element of the X-ray detector is a constant value (for example, see Patent Document 3).

### RELATED ART DOCUMENT

### Patent Document

[Patent Document 1] JP-A-2004-144572
[Patent Document 2] JP-A-2002-148211
[Patent Document 3] JP-A-2005-091016

### DISCLOSURE OF THE INVENTION

### Problem that the Invention is to Solve

However, in the above-described X-ray inspection device according to the related art, it is difficult to accurately determine whether or not a change in the detection sensitivity of the X-ray detector, such as the X-ray line sensor, over time causes performance deterioration that significantly affects the inspection of the article, and there is a case where it is not possible to accurately determine a guideline for the replacement time of the X-ray detector with respect to the actual detection performance.

For example, in a scintillator (phosphor)-type X-ray detector, even before the usage time has reached the design life, for example, the guaranteed usage time in a recommended usage environment, replacement is performed when the detection level (detection brightness value) reaches a predetermined lower limit value. As a result, preventive maintenance for avoiding a situation, in which the X-ray inspection device is unusable and the production line is stopped, in advance is achieved.

In this case, when there is a sufficient margin with respect to the predetermined lower limit value, excessively early part replacement or maintenance is required. On the other hand, when there is no margin with respect to the predetermined lower limit value, it is insufficient to achieve preventive maintenance. However, it is difficult to accurately set the lower limit value according to the inspection conditions and usage environment of each X-ray inspection device.

For example, when the production volume of articles, which are inspection objects, is large and the X-rays emitted to the X-ray detector are blocked by the inspection objects such that the exposure of the X-ray detector is suppressed to a level lower than that assumed at the time of design or when the X-ray generator is used at an output lower than the maximum rated output, the X-ray detector whose actual life is longer than the design life is replaced upon reaching its design life.

In addition, when the X-ray detector uses a scintillator, the scintillator generally has the characteristic that a performance deterioration rate is increased due to X-ray exposure in a high-temperature and high-humidity environment, and there is a case where the performance of the X-ray detector deteriorates to the extent that the X-ray detector is unusable before the assumed replacement time.

The present invention has been made in order to solve this unresolved problem, and an object of the present invention is to provide an X-ray inspection device that can accurately detect performance deterioration of an X-ray detector that significantly affects inspection of an article in advance and perform effective preventive maintenance and a preventive maintenance device for the X-ray inspection device.

### Means for Solving the Problem

According to an example of an embodiment of the present invention, there is provided an X-ray inspection device including: an X-ray irradiation unit that irradiates an article on a transport path surface with X-rays under predetermined irradiation conditions; an X-ray detector that has a plurality of detection elements arranged parallel to the transport path surface and in a direction orthogonal to a transport direction of the article and that outputs an X-ray detection signal from each of the plurality of detection elements; an inspection control unit that executes image processing for inspecting a quality state of the article based on the X-ray detection signals from the plurality of detection elements; an alignment data storage unit that stores alignment data during sensitivity correction which corresponds to the arrangement of the plurality of detection elements for each predetermined period; and deterioration sign detection means for comparing the alignment data during sensitivity correction before and after a predetermined deterioration observation period to detect a sign of performance deterioration of the X-ray detector which affects the inspection.

With this configuration, in the present invention, when each of the plurality of detection elements of the X-ray detector is corrected to have suitable detection sensitivity by the sensitivity correction, the alignment data is stored in the alignment data storage unit before the sensitivity correction of the plurality of detection elements (hereinafter, this indicates the timing immediately after the deterioration observation period and immediately before the sensitivity correction and is also simply referred to as during sensitivity correction). The alignment data stored in this case is typically alignment data in which an output difference based on the arrangement of the plurality of detection elements and an elevation angle of each detection element with respect to the incident X-rays remains and accurately shows the performance of the X-ray detector at the time of the sensitivity correction. Therefore, the alignment data during sensitivity correction stored in the alignment data storage unit is compared before and after the predetermined deterioration observation period. When significant performance deterioration of the X-ray detector occurs during the deterioration observation period, the deviation between the compared alignment data items increases, which makes it possible to accurately detect the sign of the performance deterioration of the X-ray detector that affects the inspection.

In addition, the alignment data during sensitivity correction is compared before and after the predetermined deterioration observation period corresponding to an operating environment of a manufacturing line or the like in which the X-ray inspection device is installed, for example, before and after a deterioration observation period of about a monthly inspection in a continuous operating environment or a deterioration observation period of about a semi-annual inspection in a daytime operating environment, which makes it possible to accurately and timely detect the sign of the performance deterioration of the X-ray detector that significantly affects the inspection.

In addition, the deterioration observation period referred to here can be set to about a fraction to one-tenth of the life of the X-ray detector. For example, when the guaranteed lifetime is 30000 hours, a period of 4000 hours can be set for the lifetime. Further, when the usage period of the X-ray detector is long, for example, when the usage period is shortened to the extent that the usage period enters the latter half period of the design life or the latter half of the latter half period, the deterioration observation period may be set to an observation period shorter than the initial period.

As an example of the embodiment of the present invention, the deterioration sign detection means may determine deterioration in sensitivity of the X-ray detector based on a deviation between past alignment data already stored in the alignment data storage unit and current or most recent alignment data and may detect the sign of the performance deterioration of the X-ray detector according to a determination result of the deterioration.

In this case, when the deviation between the past, for example, previous or initial alignment data and the current or most recent alignment data before and after the predetermined deterioration observation period is large, it is possible to determine that there are signs of the performance deterioration of the X-ray detector that significantly affects the inspection. When the deviation is not large, it is possible to determine that there are no signs of the performance deterioration of the X-ray detector that significantly affects the inspection.

As an example of the embodiment of the present invention, the X-ray inspection device may further include: time measurement means for measuring an irradiation time of the X-ray irradiation unit or/and an elapsed time from storage of the past alignment data in the alignment data storage unit to storage of the current or most recent alignment data; and deterioration rate calculation means for calculating a performance deterioration rate of the X-ray detector, based on the deviation between the past alignment data and the current or most recent alignment data and the irradiation time of the X-ray irradiation unit or/and the elapsed time, when the deterioration sign detection means has detected the sign of the performance deterioration of the X-ray detector.

In this case, when the sign of the performance deterioration of the X-ray detector is detected, the performance deterioration rate of the X-ray detector is calculated, which makes it possible to accurately estimate the time when the probability of performance deterioration of the X-ray detector is high.

As an example of the embodiment of the present invention, the X-ray inspection device may further include effective available inspection time calculation means for calculating an effective available inspection time until the performance deterioration of the X-ray detector which affects the inspection occurs, based on the performance deterioration rate of the X-ray detector calculated by the deterioration rate calculation means and the current or most recent alignment data, when the deterioration sign detection means has detected the sign of the performance deterioration of the X-ray detector.

In this case, when the sign of the performance deterioration of the X-ray detector is detected, it is possible to clearly understand the time until the probability of performance deterioration of the X-ray detector is high as the effective available inspection time.

As an example of the embodiment of the present invention, the X-ray inspection device may further include information output means for outputting information indicating that the sign of the performance deterioration of the X-ray detector has been detected during a period from the detection of the sign of the performance deterioration of the X-ray detector by the deterioration sign detection means to a lapse of the effective available inspection time.

In this case, when the sign of the performance deterioration of the X-ray detector is detected, it is possible to accurately output information indicating this state to the user.

As an example of the embodiment of the present invention, when the effective available inspection time is decreased to a predetermined time, the information output means may display and output the decreased effective available inspection time.

In this case, when the sign of the performance deterioration of the X-ray detector is detected and the effective available inspection time is decreased to the predetermined time, it is possible to display and output the decreased effective available inspection time in the form of indicating the arrival of the replacement time of the X-ray detector. Therefore, it is possible to timely and accurately output preventive maintenance information to the user.

As an example of the embodiment of the present invention, when the performance deterioration rate of the X-ray detector is increased beyond a predetermined degree of temporal change, the information output means may display and output the effective available inspection time decreased in an accelerated manner. As an example of the embodiment of the present invention, when a calculated value of the effective available inspection time is less than a remaining period until a design life of the X-ray detector, the information output means may display and output the effective available inspection time. As an example of the embodiment of the present invention, when the calculated effective available inspection time is shorter than a remaining period until a design life of the X-ray detector, the information output means may display and output the effective available inspection time.

In these cases, it is possible to timely and accurately output, to the user, information indicating that the probability of performance deterioration of the X-ray detector which significantly affects the inspection is high and the arrival of the replacement time, from changes in the performance deterioration rate and effective available inspection time of the X-ray detector.

As an example of the embodiment of the present invention, the alignment data may be stored in the alignment data storage unit as data converted into reference converted alignment data which is an index of performance of the X-ray detector.

In this case, even when the inspection conditions can be changed due to, for example, the switching of the type of the inspection object during long-term use of the device, the alignment data is data effective for deterioration determination considering a change in the X-ray output of the X-ray irradiation unit, a change in the transport speed in the article transport unit, or the like since the alignment data is converted into reference converted alignment data which is an index of the performance of the X-ray detector. Therefore, it is possible to accurately calculate the performance deterioration rate of the X-ray detector according to the actual situation of the user, regardless of the change in the inspection conditions due to the switching of the type of the inspection object or the like. As a result, the accuracy of preventive maintenance is improved.

As an example of the embodiment of the present invention, there is provided a preventive maintenance device for an X-ray inspection device, the preventive maintenance device performing preventive maintenance of the X-ray inspection device including an X-ray irradiation unit that irradiates an article on a transport path surface with X-rays under predetermined irradiation conditions, an X-ray detector that has a plurality of detection elements arranged parallel to the transport path surface and in a direction orthogonal to a transport direction of the article and that outputs an X-ray detection signal from each of the plurality of detection elements, and an inspection control unit that executes image processing for inspecting a quality state of the article based on the X-ray detection signals from the plurality of detection elements, the preventive maintenance device including: an alignment data storage unit that stores alignment data during sensitivity correction which corresponds to the arrangement of the plurality of detection elements for each predetermined period; and deterioration sign detection means for comparing the alignment data during sensitivity correction before and after a predetermined deterioration observation period to detect a sign of performance deterioration of the X-ray detector which affects the inspection.

With this configuration, in the preventive maintenance device according to the embodiment of the present invention, when each of the plurality of detection elements of the X-ray detector is corrected to have suitable detection sensitivity by the sensitivity correction, the alignment data is stored in the alignment data storage unit before the sensitivity correction of the plurality of detection elements. Then, the alignment data during sensitivity correction stored in the alignment data storage unit is compared before and after the predetermined deterioration observation period. When significant performance deterioration of the X-ray detector occurs during the deterioration observation period, the deviation between the compared alignment data items increases, which makes it possible to accurately detect the sign of the performance deterioration of the X-ray detector that affects the inspection. In addition, the alignment data during sensitivity correction is compared before and after the predetermined deterioration observation period corresponding to an operating environment of a manufacturing line or the like in which the X-ray inspection device is installed, for example, before and after a deterioration observation period of about a monthly inspection in a continuous operating environment or a deterioration observation period of about a semi-annual inspection in a daytime operating environment, which makes it possible to accurately and timely detect the sign of the performance deterioration of the X-ray detector that significantly affects the inspection.

### ADVANTAGE OF THE INVENTION

According to the present invention, it is possible to provide an X-ray inspection device that can accurately detect performance deterioration of an X-ray detector that significantly affects inspection of an article in advance and perform effective preventive maintenance and a preventive maintenance device for the X-ray inspection device.

### BRIEF DESCRIPTION OF THE DRAWINGS

FIG. 1 is a schematic view showing a configuration of an X-ray inspection device according to an embodiment of the present invention.

FIG. 2 is an enlarged cross-sectional view showing a main portion of an X-ray detector of the X-ray inspection device according to the embodiment of the present invention, which shows an arrangement state of a plurality of X-ray detection elements of the X-ray detector of the X-ray inspection device.

FIG. 3 is a graph showing non-uniform alignment data before sensitivity correction of the plurality of X-ray detection elements of the X-ray detector in the X-ray inspection device according to the embodiment of the present invention, in which detection element output (Lx) is associated with an element number for each of a state (Ct0) in which there is no article or calibration member in an imaging region (Zx), a state (Ctf) in which a first calibration member having a low X-ray transmittance is carried in, and a state (Cts) in which a second calibration member having a medium-to-high X-ray transmittance is carried in, a vertical axis indicates a detection element output level (Lx), and a horizontal axis indicates the element numbers of the plurality of detection elements.

FIG. 4 is a characteristic view showing a characteristic in which an incident X-ray amount on each detection element of the X-ray detector in the X-ray inspection device according to the embodiment of the present invention changes depending on the X-ray transmittance of an X-ray irradiation path, in which a vertical axis indicates a detection element output level corresponding to X-ray image density (brightness), and a horizontal axis indicates an incident X-ray amount on the detection element.

FIG. 5 is a schematic view showing alignment data during sensitivity correction of the plurality of X-ray detection elements of the X-ray detector in the X-ray inspection device according to the embodiment of the present invention and a sensitivity correction amount corresponding to the arrangement of the elements.

FIG. 6 is a schematic view showing remaining life display according to an example in which a remaining life of the X-ray detector is shown in the form of a bar graph on a normal inspection screen in the X-ray inspection device according to the embodiment of the present invention.

FIG. 7 is a graph showing a stepwise procedure from a process of calculating a performance deterioration rate corresponding to a decrease in a data storage value per deterioration observation period and an effective available inspection time Tei corresponding to the performance deterioration rate, based on most recent alignment data corresponding to a predetermined number of times stored in a sensitivity correction data storage unit for each predetermined deterioration observation period in the X-ray inspection device according to the embodiment of the present invention to a process of notifying of the replacement time of the X-ray detector due to a decrease in inspection performance, in which a vertical axis indicates the value of the reference converted alignment data and a horizontal axis indicates the X-ray irradiation time of the X-ray irradiation unit.

FIG. 8 is a view showing a notification screen according to an example in which pop-up display is provided to notify that the replacement time of the X-ray detector is approaching at the timing when the remaining life of the X-ray detector in the X-ray inspection device according to the embodiment of the present invention is nearly exhausted.

FIG. 9 is a view showing a notification screen according to another example in which text is displayed in an upper portion of a normal inspection screen while an alarm is being issued to notify that the replacement time of the X-ray detector is approaching at the timing when the remaining life of the X-ray detector in the X-ray inspection device according to the embodiment of the present invention is nearly exhausted.

FIG. 10 is a view showing a notification screen according to still another example in which, while an alarm is being issued to notify that the replacement time of the X-ray detector is approaching at the timing when the remaining life of the X-ray detector in the X-ray inspection device according to the embodiment of the present invention is nearly exhausted, a screen including a perspective view showing the alarm notification state is displayed.

FIG. 11 is a schematic view showing remaining life display according to yet another example in which the remaining life of the X-ray detector is displayed in a status monitor format on the normal inspection screen of the X-ray inspection device according to the embodiment of the present invention.

### BEST MODE FOR CARRYING OUT THE INVENTION

Hereinafter, embodiments of the present invention will be described with reference to the drawings.

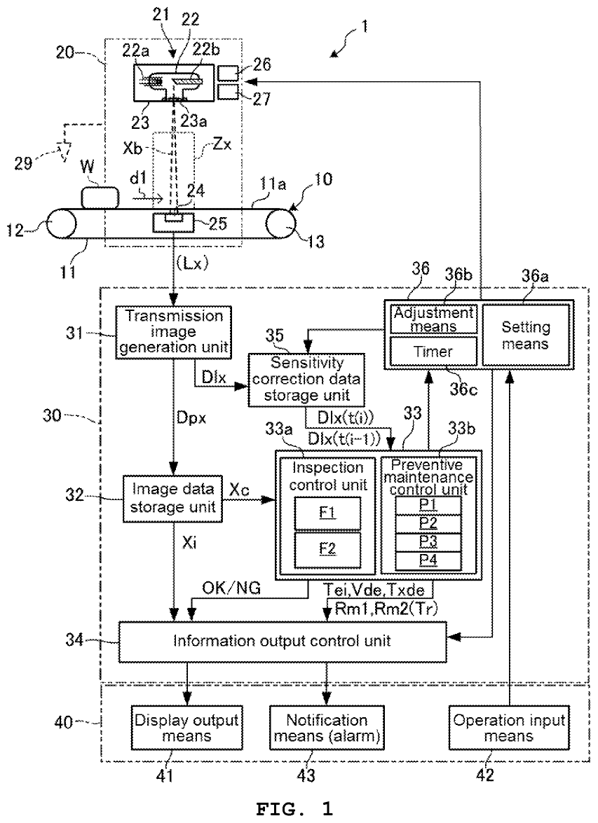

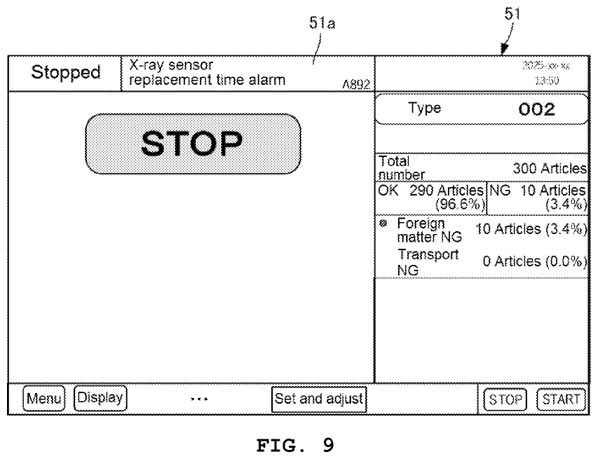

FIGS. 1 to 8 show a configuration of an X-ray inspection device according to an embodiment of the present invention, functions thereof related to sensitivity correction, and operating states thereof, and FIGS. 9 to 11 show a plurality of other aspects of a display screen that requires preventive maintenance.

First, the configuration of the X-ray inspection device will be described.

An X-ray inspection device 1 shown in FIG. 1 includes an article transport unit 10, an X-ray imaging unit 20, a control device 30, and an information input/output unit 40 and constitutes a portion of an article inspection system in which, for example, a sorting device (not shown) or the like is provided in a stage subsequent to the article transport unit 10.

The article transport unit 10 transports an article W, which is an inspection object, in a predetermined transport direction d1 and is configured such that, for example, a loop-shaped transport belt 11 is stretched between parallel rollers 12 and 13 and the article W passes through the inside of an imaging region Zx of the X-ray imaging unit 20 while being transported at a constant speed on a transport path 11a which is an upper running section of the transport belt 11. Here, the article transport unit 10 is a belt conveyor in which any of the rollers 12 and 13 is driven by a motor, and the transport path 11a is flat. However, a transport method is not particularly limited.

The X-ray imaging unit 20 includes an X-ray irradiation unit 21 and an X-ray detector 25 having an X-ray detection element group 24 (a plurality of X-ray detection elements) arranged in an array, between which the transport path 11a of the article transport unit 10 is interposed. Here, for example, the X-ray irradiation unit 21 and the X-ray detector 25 are disposed to face each other while being spaced apart above and below in a vertical direction. However, the X-ray irradiation unit 21 and the X-ray detector 25 may be disposed to be spaced apart in both the vertical direction and a horizontal direction.

For example, the X-ray irradiation unit 21 has an X-ray tube 22 in a tank 23 that is made of metal, and has a configuration in which the X-ray tube 22 is immersed in insulating oil (not shown) for cooling in the tank 23. In addition, for example, the X-ray tube 22 is configured such that electrons, which have been emitted from a filament on the side of a cathode 22a in an outer casing and focused by a focusing electrode, collide with a target on the side of an anode 22b facing the filament and X-rays in a predetermined energy range are generated from the target.

The X-ray imaging unit 20 further includes one drive power supply circuit 26 and the other drive power supply circuit 27. The one drive power supply circuit 26 applies a potential corresponding to a predetermined operating voltage to the focusing electrode (not designated by reference numeral) on the side of the cathode 22a of the X-ray tube 22 and applies a predetermined ignition voltage for giving thermionic emission energy to the filament (not designated by reference numeral) on the side of the cathode 22a. In addition, the other drive power supply circuit 27 applies a positive potential corresponding to a high operating anode voltage to the anode 22b of the X-ray tube 22. That is, the one drive power supply circuit 26 is configured to include a so-called filament power supply circuit, and the other drive power supply circuit 27 is configured to include a high-voltage circuit that applies a high voltage between the filament and the target of the X-ray tube 22.

The X-ray irradiation unit 21 irradiates the imaging region Zx, into which the article W is carried, in the transport path 11a of the article W by the article transport unit 10 with X-rays. In the present embodiment, the X-ray irradiation unit 21 has the X-ray tube 22 that irradiates the article W with an X-ray beam Xb from above to below in the vertical direction. However, the irradiation direction of the X-rays from the X-ray irradiation unit 21 is not limited to the downward direction, but may be other directions.

The X-ray beam Xb generated by the X-ray tube 22 is emitted downward from an X-ray window portion 23a with a slit on the bottom side of the tank 23 toward the imaging region Zx, into which the article W is carried, as a fan beam that spreads in a line scanning direction orthogonal to the transport direction d1. In addition, the anode of the X-ray tube 22 may be either a fixed type or a rotating type.

The X-ray detection element group 24 is arranged parallel to the transport path 11a and in the line scanning direction orthogonal to the transport direction d1. Here, the X-ray detection element group 24 has a scintillator-integrated sensor structure of an indirect conversion type. However, it goes without saying that the X-ray detector 25 may be a direct conversion type that performs photon counting.

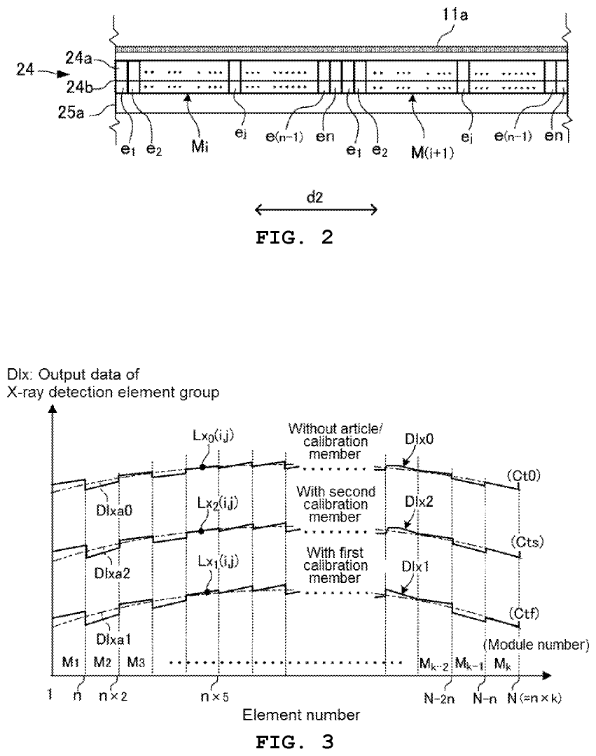

As shown in a partially enlarged view of FIG. 2, the X-ray detection element group 24 is composed of a plurality of, for example, k sensor modules Mi, M(i+1), and the like that are arranged to be aligned in a line scanning direction d2. Each sensor module Mi (here, i is any natural number equal to or less than the total number k of modules) is composed of a plurality of scintillators 24a or an integrated scintillator 24a provided on the side of the transport path 11a on which the X-rays are incident from the X-ray irradiation unit 21 and a photodiode array 24b (a plurality of light-receiving elements) having a plurality of, for example, n light-receiving elements e1 to en that detect fluorescence from the scintillator 24a which corresponds to the incident X-ray amount. In addition, the X-ray detector 25 has a detection substrate 25a on which a plurality of photodiode arrays 24b are mounted in a row.

X-rays in a predetermined X-ray energy range emitted from the X-ray irradiation unit 21 are absorbed while being transmitted through the scintillator 24a of each sensor module Mi, and the scintillator 24a generates scintillation light corresponding to the incident X-ray amount.

In addition, the photodiode array 24b is configured such that a plurality of photodiodes (light-receiving elements) adjacent to each other in the line scanning direction d2 receive the scintillation light from the scintillator 24a. Here, for example, when the width of each light-receiving element in the photodiode array 24b is 1 mm, a gap between adjacent light-receiving elements is small enough to be negligible with respect to the width of the sensor, and the width of the transport path 11a for transporting the article W in the width direction (the line scanning direction d2 in FIG. 2) is 200 mm, the entire X-ray detector 25 may use the required number of photodiode arrays 24b such that the X-ray detector 25 has approximately N (=200) light-receiving elements.

In this case, the plurality of photodiode arrays 24b have N, for example, k×n charge-accumulation-type light-receiving elements that receive the scintillation light from the corresponding scintillators 24a, accumulate photocurrents generated simultaneously by the N light-receiving elements for a predetermined accumulation time, and output a brightness detection signal Lx, which is a voltage signal, based on charge corresponding to the product of the photocurrent and the accumulation time.

X-ray detection circuits corresponding to the N light-receiving elements of the photodiode array 24b mounted on the detection substrate 25a are provided in the X-ray detector 25. For example, an A/D converter and a clock generation circuit (not shown) are provided in the X-ray detection circuit, and each of electric signals from the N light-receiving elements is converted into a multi-gradation digital signal.

The detection substrate 25a of the X-ray detector 25 may include, for example, a parallel/serial converter (not shown) and a clock generation circuit that generates a parallel clock signal for parallel output of the multi-gradation digital signals from the A/D converter to the parallel/serial converter. In this case, the multi-gradation digital signal can be converted into a time-series voltage signal by the parallel/serial converter in synchronization with a clock signal cycle, and the brightness detection signal Lx can be output. Of course, at least some of the detection circuits mounted on the detection substrate 25a may be included in the control device 30.

The control device 30 has a transport control function of controlling the transport speed, transport interval, and the like of the article W by the transport belt 11 in the article transport unit 10, an inspection control function of controlling the X-ray irradiation intensity and irradiation period of the X-ray imaging unit 20 and controlling an X-ray detection cycle of the X-ray detector 25, a detection period of each article W, and the like corresponding to the transport speed of the article W, and a preventive maintenance control function of detecting the performance deterioration of at least the X-ray detector 25 in advance and performing preventive maintenance.

As shown in FIG. 1, the control device 30 generates an X-ray transmission image Dpx for inspection and an X-ray inspection image Xi for display based on the brightness detection signal Lx from the X-ray detector 25 and executes predetermined inspection control based on an X-ray transmission image Xc for each article W.

The control device 30 has a hardware configuration including, for example, a processor having a CPU, a ROM, a RAM, and an I/O interface, an auxiliary storage device that stores a control program for implementing various functions to be readable in cooperation with the ROM, a timer circuit, a driver circuit, and the like, which is not shown in detail. The CPU executes predetermined arithmetic processing while exchanging data with the RAM and the like, according to software such as the control program and setting information stored in the ROM and the like, and executes the control program. The hardware may include a field programmable gate array (FPGA), a digital signal processor (DSP), and the like. In addition, the various functions referred to here are functions of each functional unit and means for X-ray output control, generation of X-ray image data, inspection control, display output control, preventive maintenance control, and the like which will be described below.

Specifically, first, the control device 30 has a transmission image generation unit 31, an image data storage unit 32, and an information output control unit 34 and can generate the X-ray transmission image Dpx for inspection and the X-ray inspection image Xi for display using these units. In addition, the control device 30 has a control unit 33 for exhibiting the inspection control function and the preventive maintenance function, a sensitivity correction data storage unit 35 (alignment data storage unit), and an inspection condition setting adjustment unit 36.

The transmission image generation unit 31 converts the brightness detection signal Lx from the X-ray detector 25 into parallel digital signals corresponding to the number of gradations, and the converted multi-gradation digital signal is output to the image data storage unit 32 as the image data Dpx of a line image in which an X-ray transmission amount at each pixel position for each line scanning operation of the article W is the corresponding pixel density.

The image data storage unit 32 has an image memory function of temporarily storing the X-ray image data Dpx acquired by the transmission image generation unit 31 for each line scanning period in sequence, and can generate the X-ray transmission image Xc for inspection and the X-ray inspection image Xi for display based on the X-ray image data Dpx from the transmission image generation unit 31.

In addition, the image data storage unit 32 can transfer image data of an X-ray transmission image, which has been acquired during a predetermined number of line scanning operations and show a part or all of the article W, as the X-ray transmission image Xc for inspection to the control unit 33 at a predetermined reading cycle and can transfer the image data of the X-ray transmission image showing the article W as the X-ray inspection image Xi for display to the information output control unit 34. In addition, the predetermined reading cycle referred to here means, for example, a time corresponding to an image generation period for sequential inspection or/and display of each article W which is set according to the length of each article W in the transport direction and the transport speed of each article W, based on the timing when the article W is carried in the article transport unit 10 detected by the article detection sensor 29.

The control unit 33 has an inspection control unit 33a exhibiting the functions of an image processing unit F1 that executes predetermined image processing based on the X-ray image data Xc input from the image data storage unit 32 and inspection determination means F2 for determining a predetermined quality state of the article W based on the image processing results of the image processing unit F1.

The inspection control unit 33a performs determination image processing of a predetermined image processing algorithm, using the X-ray image data Xc stored in the image data storage unit 32, according to determination processing conditions that have been preset and stored and operating conditions during an inspection operation additionally set by operating condition setting means 36a, and determines whether a defective portion, such as a foreign matter or a bone, is present or absent in the article W based on the image data subjected to the image processing.

The predetermined image processing algorithm used in the inspection control unit 33a is, for example, a combination of a plurality of image processing filters and image processing for feature extraction and is, for example, a process of emphasizing a sudden change in an image density value near the contour of the foreign matter for clarity or a process of detecting an edge or a line corresponding to the contour of the foreign matter or a fixed content, in order to automatically detect whether or not the foreign matter is contained in the article W or whether or not there is a missing article.

The information output control unit 34 has a function of executing, for example, image processing suitable for a visual determination process or visual check work for each line scanning period, such as image processing of setting a tone gradation level based on the result of logarithmic conversion from a detection signal level corresponding to the sensitivity of the human eye, based on the X-ray inspection image Xi for display from the image data storage unit 32 during the inspection of the article.

The inspection condition setting adjustment unit 36 includes the setting means 36a, adjustment means 36b, and a timer 36c and has a function of variably setting a measurement period, which is a period for which the detection signal is acquired from the X-ray detector 25 to the transmission image generation unit 31, according to the detection signal of the article detection sensor 29.

In addition, the inspection condition setting adjustment unit 36 has a function of variably setting the output of the X-rays (X-ray intensity; tube voltage ×tube current of the X-ray tube 22) generated and emitted by the X-ray irradiation unit 21 to a plurality of output values differing in magnitude or correcting the sensitivity of the X-ray detection element group 24 (a plurality of X-ray detection elements) of the X-ray detector 25, in cooperation with the one drive power supply circuit 26 and the other drive power supply circuit 27.

Specifically, the filament power supply circuit configured in the one drive power supply circuit 26 has an inverter circuit that is controlled by a current control circuit and a high-frequency transformer, and the inverter circuit can perform a power supply voltage switching operation to perform current output control corresponding to an energization time ratio. In addition, the high-voltage circuit configured in the other drive power supply circuit 27 can perform voltage output control corresponding to the type of the article W using a voltage control circuit thereof.

Further, the inspection condition setting adjustment unit 36 has the setting means 36a for setting a target value of the current in the current control circuit of the one drive power supply circuit 26 and a target value of the voltage in the voltage control circuit of the other drive power supply circuit 27 for each type of the article W and storing the target values and the adjustment means 36b for adjusting the control gain of each of the current control circuit of the one drive power supply circuit 26 and the voltage control circuit of the other drive power supply circuit 27 such that the target value of the current and the target value of the voltage set by the setting means 36a are obtained.

However, in the present embodiment, the inspection condition setting adjustment unit 36 performs the inspection operation for an inspection object of one type or similar inspection objects having the same inspection conditions as the article W under the same X-ray irradiation conditions for a long period, here, for a predetermined deterioration observation period corresponding to an operating environment of a production line or the like, for example, a long period in which the cumulative irradiation time of the X-ray irradiation unit 21 is several thousand hours, for example, 4000 hours or more.

In addition, the predetermined deterioration observation period referred to here is a period long enough to compare the alignment data during sensitivity correction before and after the deterioration observation period, for example, before and after a deterioration observation period of about a monthly inspection in a continuous operating environment or before and after a deterioration observation period of about a semi-annual (six-month) inspection in a daytime operating environment, and corresponds to a cumulative irradiation time Txde which will be described below. Hereinafter, the deterioration observation period set to the same time as the cumulative irradiation time Txde, which will be described below, is also simply referred to as a deterioration observation period Txde. Further, the deterioration observation period Txde may be set to a short period according to the usage period of the X-ray detector 25 when the usage period is long, for example, when the deterioration observation period Txde is shortened to the extent that the deterioration observation period Txde enters the latter half period of the design life (for example, 30000 hours) of the X-ray detector 25 or the latter half of the latter half period.

The inspection condition setting adjustment unit 36 can set and adjust image data generation conditions of the transmission image generation unit 31, that is, the conversion conditions for converting the brightness detection signal Lx from the X-ray detector 25 into parallel digital signals corresponding to the number of gradations, during the sensitivity correction of the X-ray detector 25. A preventive maintenance control unit 33b which will be described below requests mode switching for sensitivity correction or deterioration determination when necessary sensitivity correction has not been executed such that, although the inspection operation is performed under the same X-ray irradiation conditions over a long period, the sensitivity correction of the X-ray detector 25 is executed at least once each time the predetermined deterioration observation period Txde elapses.

Specifically, during the sensitivity correction of the X-ray detector 25, the X-ray irradiation unit 21 emits X-rays in a predetermined energy range with the X-ray output (tube current×tube voltage) set according to the type of the article W. In this case, as shown in FIG. 3, for the detection element outputs Lx of element numbers 1 to N in the X-ray detection element group 24 of the X-ray detector 25, a brightness detection signal Lx(i, j), which is the output from the light-receiving element e (hereinafter, referred to as an X-ray detection element e(i, j)) of any element number j in any sensor module Mi, is larger on the central side of the X-ray detector 25 in the longitudinal direction and is smaller toward both end sides (the side of the minimum element number and the side of the maximum element number), due to a difference in the angle (elevation angle) of the X-ray beam Xb incident on each pixel region with respect to the surface of the scintillator 24a.

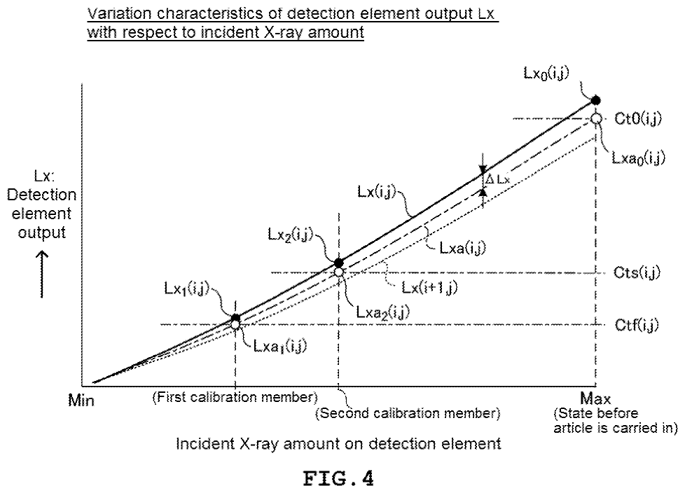

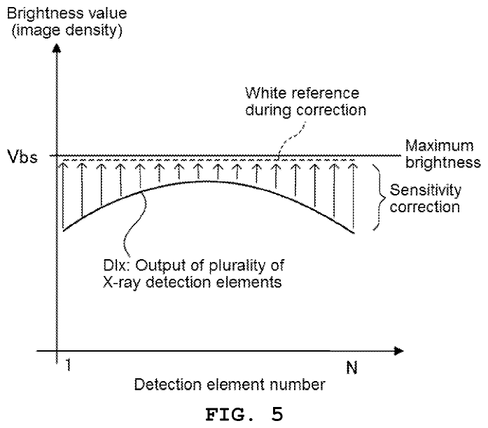

In addition, as shown in FIGS. 3 and 4, output data Dlx (outputs Lx(1, 1) to Lx(k, n) of all of the detection elements e1 to eN) corresponding to the output Lx of the X-ray detection element group 24 is large in a high transmittance state Ct0 (a state before the article is carried in) in which the article W or a calibration member, which will be described below, is not present in the imaging region Zx, is small in a low transmittance state Ctf in which a first calibration member with a low X-ray transmittance is carried in, and is intermediate in a medium transmittance state Cts in which a second calibration member with a medium-to-high X-ray transmittance is carried in the imaging region Zx. In addition, the calibration member referred to here is a plate with a constant thickness whose transmittance can be attenuated by a constant amount to the same extent as the article W across the entire width of the X-ray detector 25 when passing through the imaging region Zx and is made of, for example, a resin. The calibration member may be a member formed by integrating the first calibration member and the second calibration member that are adjacent to each other in the transport direction d1 and have different thicknesses.

An example of the procedure of a sensitivity correction process on the X-ray detection element group 24 of the X-ray detector 25 will be described. For example, when the X-rays from the X-ray irradiation unit 21 are incident on the scintillator 24a of each sensor module Mi of the X-ray detector 25 after the tube voltage of the X-ray tube 22 is determined to be a predetermined tube voltage by an automatic sequence during initial setting by master workpiece transport, the inspection condition setting adjustment unit 36 executes sensitivity correction to adjust N detection element outputs Lx(1, 1) to Lx(k, n), which are the output Dlx of the X-ray detection element group 24, to theoretical values Dlxa corresponding to the detection positions thereof, sets the tube current of the X-ray tube 22 suitable for the correction, and sets the output of the X-ray irradiation unit 21.

This sensitivity correction is correction that is executed to align the outputs of the plurality of detection elements e1 to eN with alignment data including a difference in detection characteristics based on the arrangement of the detection elements and a difference in the elevation angle of each detection element e(i, j) with respect to the incident X-rays, in addition to a variation in the detection characteristics of each of the plurality of detection elements e1 to eN of the X-ray detection element group 24 and is usually executed as, for example, shading correction shown in a schematic view of FIG. 5 during the use of the X-ray inspection device 1. Further, the shading correction referred to here is a correction process of aligning the outputs of all of the detection elements e1 to eN of the X-ray detection element group 24 and aligning the outputs to a white reference (a certain belt surface brightness value equivalent to the brightness value of the background) corresponding to approximately the maximum detection brightness Vbs of the X-rays within a predetermined energy range.

More specifically, the sensitivity correction referred to in the present invention may be a correction process that sets the output data Dlx of the X-ray detection element group 24, for example, non-uniform output data Dlx0, which is on the high output side in the high transmittance state Ct0 within the imaging region Zx and changes in level due to the difference in the elevation angle corresponding to the detection position of the output Lx(i, j) of each detection element as shown in FIG. 3, as the data to be aligned and aligns the output data Dlx0 with a theoretical output Dlxa0 which is on the high output side in the high transmittance state Ct0 and changes in level due to the difference in the elevation angle.

Alternatively, the sensitivity correction referred to in the present invention may be a correction process that divides the output into high and low output levels according to the transmittance states Ct0, Ctf, and Cts within the imaging region Zx, sets the non-uniform output data items Dlx0, Dlx1, and Dlx2, which change in level due to the difference in the elevation angle, as the data to be aligned, and aligns the output data items Dlx0, Dlx1, and Dlx2 with theoretical outputs Dlxa0, Dlxa1, and Dlxa2 which differ in level according to the transmittance states Ct0, Ctf, and Cts, respectively.

In the latter case, as shown in FIG. 4, for example, the sensitivity correction may be performed to correct a characteristic curve for each element (correction corresponding to ΔLx in FIG. 4) such that, for the brightness detection signal Lx(i, j) for each X-ray detection element e(i, j), the detection element outputs Lx0(i, j), Lx1(i, j), and Lx2(i, j) before correction in the high transmittance state Ct0, the low transmittance state Ctf, and the medium transmittance state Cts are correction target values Lxa0(i, j), Lxa1(i, j), and Lxa2(i, j) (white circle marks in FIG. 4) which are theoretical values, respectively, and a detection characteristic curve Lx(i, j) of any X-ray detection element e(i, j) or a detection characteristic curve Lx(i+1, j) of the X-ray detection element e(i+1, j) of an adjacent sensor module M(i+1) is close to an ideal characteristic Dlxa(i, j).

The X-ray inspection device 1 according to the present embodiment that performs this sensitivity correction includes the X-ray irradiation unit 21 that irradiates the article W on the transport path 11a with the X-rays Xb under predetermined (default) irradiation conditions, the X-ray detector 25 that has k sensor modules M1 to Mk, each of which has a plurality of detection elements e1 to en (N=k×n detection elements) and which are arranged parallel to the transport path 11a and in a direction orthogonal to the transport direction d1 of the article W, and that outputs each of the X-ray detection signals Lx from a plurality of sets (k sets) of X-ray detection elements e1 to en, and the inspection control unit 33a that executes image processing for inspecting the quality state of the article W based on the X-ray detection signals Lx from the plurality of sets of X-ray detection elements e1 to en. In addition, the X-ray inspection device 1 further includes the preventive maintenance control unit 33b having the following configuration.

That is, the X-ray inspection device 1 according to the present embodiment further includes the sensitivity correction data storage unit 35 that stores the alignment data Dlx during the sensitivity correction of N detection elements or an integer multiple thereof corresponding to the arrangement of the plurality of sets of X-ray detection elements e1 to en and the preventive maintenance control unit 33b that executes control to perform preventive maintenance on at least the X-ray detector 25 of the X-ray inspection device 1 based on the information stored in the sensitivity correction data storage unit 35.

The frequency of storing the alignment data by the sensitivity correction data storage unit 35 can be set to about once every 4000 hours as described above, and the alignment data during the sensitivity correction executed during this period may be further stored. In addition, it may be possible to check the performance deterioration of the X-ray detector 25 after the initial alignment data is stored in a relatively short period with respect to the deterioration observation period in a detailed manner while ensuring a time interval required as the deterioration observation period which will be described below.

As described above, the alignment data Dlx to be stored in the sensitivity correction data storage unit 35 may be the data before sensitivity correction shown in FIG. 3 or the data after sensitivity correction as long as the alignment data Dlx is the data of the detection element output Lx after sensitivity correction (belt surface correction) shown in FIG. 5.

However, when the inspection conditions (the tube voltage, the tube current, the transport speed, and the like) can be changed by the switching of the type of inspection object and the like, the alignment data Dlx can be stored as reference converted alignment data for each predetermined time corresponding to the deterioration observation period. In this case, for the alignment data Dlx, the data of the detection element output Lx before sensitivity correction shown in FIG. 5 is converted into reference converted alignment data, using a reference conversion coefficient Fc=(reference X-ray output Px1 [W]/set X-ray output Px2 [W])×(set scanning speed Vs2 [scan/s]/reference set scanning speed Vs1 [scan/s]), and the reference converted alignment data is stored in the sensitivity correction data storage unit 35.

Here, the reference X-ray output Px1 is a power value corresponding to the product of a tube voltage value and a tube current value which are set in advance as a reference tube voltage and a reference tube current in the X-ray tube 22 of the X-ray irradiation unit 21, and the set X-ray output Px2 is a power value corresponding to the product of a tube voltage value and a tube current value which are set in the X-ray tube 22 of the X-ray irradiation unit 21 before sensitivity correction immediately after the lapse of each deterioration observation period Txde. In addition, the reference set scanning speed Vs1 is a transport speed value that is set in advance as a reference transport speed when the transport belt 11 is driven in the article transport unit 10 to transport the article W, and the set scanning speed Vs2 is a transport speed value that has already been set as a transport speed when the article W is transported in the article transport unit 10 before sensitivity correction immediately after the lapse of each deterioration observation period Txde.

In addition, the alignment data Dlx stored in the sensitivity correction data storage unit 35 may be not all of the data of the detection element output Lx, but may be data of the minimum value corresponding to the lowest value (minimum brightness) among the output values specified by the data of all of the elements. Alternatively, the alignment data Dlx may be a portion of the data indicating the feature amount of the alignment data, such as data of an average value corresponding to average brightness, data of the maximum value and the minimum value, and output data of only the X-ray detection elements at a plurality of detection positions (element numbers) corresponding to specific element numbers. Further, the data of the minimum value corresponding to the lowest value (minimum brightness) can include the detection element output data of a predetermined number of detection elements in the vicinity thereof. In this case, for example, the data can be the output data of a plurality of sets of detection elements from the minimum element number (element number 1 in FIG. 3) to a predetermined number and from the maximum element number (element number N in FIG. 3) to a predetermined number. In addition, it is also conceivable to store the average value for each of the plurality of sensor modules M1 to Mk and data of the minimum value, the maximum value, the average value, and the like.

Furthermore, data of belt surface noise that causes variations in each detection element output Lx0(i, j) of the X-ray detection element group 24 in the high transmittance state Ct0 with respect to the theoretical output Dlxa0 represented by a two-dot chain line in FIG. 3 for the high transmittance state Ct0, data of dark current noise that appears in the X-ray detection element group 24 of the X-ray detector 25 in a state in which no X-rays are emitted, and the like may be stored in the sensitivity correction data storage unit 35 together with the alignment data Dlx.

The preventive maintenance control unit 33b has deterioration sign detection means P1 for comparing the alignment data Dlx during sensitivity correction, which is the information stored in the sensitivity correction data storage unit 35, before and after the predetermined deterioration observation period Txde to detect signs of the performance deterioration of the X-ray detector 25 that affects the inspection. Then, the deterioration sign detection means P1 determines the sensitivity deterioration of the X-ray detector 25 based on the deviation between the past alignment data Dlx(t(i−1)) already stored in the sensitivity correction data storage unit 35 and the current or most recent alignment data Dlx(t(i)) and detects the signs of the performance deterioration of the X-ray detector 25 according to the determination result of the deterioration.

The predetermined deterioration observation period referred to here is set and stored in advance in the setting means 36a of the inspection condition setting adjustment unit 36, and the time measurement means 36c of the inspection condition setting adjustment unit 36 measures, as the predetermined deterioration observation period, the cumulative irradiation time of the X-ray irradiation unit 21 or/and the elapsed time (hereinafter, simply referred to as the cumulative irradiation time Txde) from the storage of the past alignment data Dlx(t(i−1)) in the sensitivity correction data storage unit 35 to the storage of the current or most recent alignment data Dlx(t(i)).

In addition, the preventive maintenance control unit 33b has, as a further functional unit, deterioration rate calculation means P2 for calculating a performance deterioration rate Vde (=(Dlx(t(i−1))−Dlx(t(i)))/Txde) of the X-ray detector 25 based on the deviation between the past alignment data Dlx(t(i−1)) and the current or most recent alignment data Dlx(t(i)) and the cumulative irradiation time Txde of the X-ray irradiation unit 21 when the deterioration sign detection means P1 detects the signs of the performance deterioration of the X-ray detector 25.

Further, the preventive maintenance control unit 33b further has effective available inspection time calculation means P3 for calculating an effective available inspection time Tei until the performance deterioration of the X-ray detector 25 that affects the inspection occurs, based on the performance deterioration rate of the X-ray detector 25 calculated by the deterioration rate calculation means P2 and the current or most recent alignment data Dlx(t(i)) when the deterioration sign detection means P1 detects the signs of the performance deterioration of the X-ray detector 25.

In addition, the preventive maintenance control unit 33b has, as a further functional unit, information output means P4 for outputting screen information Rm1 or/and audio information Rm2 indicating that the signs of the performance deterioration of the X-ray detector 25 have been detected and that preventive maintenance work is required during the period from the detection of the signs of the performance deterioration of the X-ray detector 25 by the deterioration sign detection means P1 to the lapse of the effective available inspection time Tei.

The information output means P4 exhibits a function of, when the effective available inspection time Tei is decreased to a predetermined time, outputting information indicating the decreased effective available inspection time Tei on a display screen of display output means 41 in the form of indicating the arrival of the replacement time of the X-ray detector 25. When the performance deterioration rate Vde of the X-ray detector 25 is increased beyond a predetermined degree of temporal change as a display output condition, the information output means P4 further displays and outputs the effective available inspection time Tei decreased in the accelerated manner.

In addition, when the calculated value of the effective available inspection time Tei is less than the design life of the X-ray detector 25, for example, the lower limit remaining period Tr from the start of use to 30000 hours, the information output means P4 may display and output the effective available inspection time Tei. Alternatively, when the effective available inspection time Tei calculated in the current process is already shorter than the lower limit remaining period Tr until the design life of the X-ray detector 25, the information output means P4 may display and output the effective available inspection time Tei.

The information input/output unit 40 has, for example, the functions of the display output means 41 and operation input means 42 that can be implemented by a touch panel and the functions of notification means 43 that can output an alarm to perform notification when preventive maintenance is required.

The function of the display output means 41 is a function of displaying various types of information required for X-ray inspection on the display screen, in addition to the operating state, setting information, and the like of the X-ray inspection device 1. In addition, the function of the operation input means 42 is, for example, a function of performing various touch panel operations, such as an operation of selecting a display screen, a mode switching operation of selecting whether an operation mode is an inspection mode, a setting mode, or another mode, and an operation of inputting various parameter settings in the setting mode, and is a function of inputting request information corresponding to the operation input of the user.

The information input/output unit 40 is not limited to the touch panel integrated with the X-ray inspection device 1 and may be a unit that is provided in the form of a portable tablet-type information terminal or the like or a unit that is additionally installed in the form of a display, an operation panel, or the like different from the touch panel integrated with the X-ray inspection device 1.

Next, the operation will be described.

In the X-ray inspection device 1 according to the present embodiment having the above-described configuration, during the sensitivity correction of the X-ray detection element group 24 which is a plurality of detection elements of the X-ray detector 25, a portion or all of the alignment data Dlx before sensitivity correction shown in FIG. 5 is stored as data indicating at least the characteristics thereof in the sensitivity correction data storage unit 35. As described above, the alignment data Dlx stored at the time of sensitivity correction accurately indicates the detection characteristics (the detection characteristics before sensitivity correction) of the X-ray detection element group 24 of the X-ray detector 25 at the time of sensitivity correction. Therefore, the alignment data during sensitivity correction stored in the sensitivity correction data storage unit 35 is compared before and after the predetermined deterioration observation period Txde. When significant performance deterioration of the X-ray detector 25 occurs during the deterioration observation period Txde, the deviation between the compared alignment data items Dlx(t(i)) and Dlx(t(i−1)) increases, which makes it possible to accurately detect the signs of the performance deterioration of the X-ray detector 25 that affects the inspection.

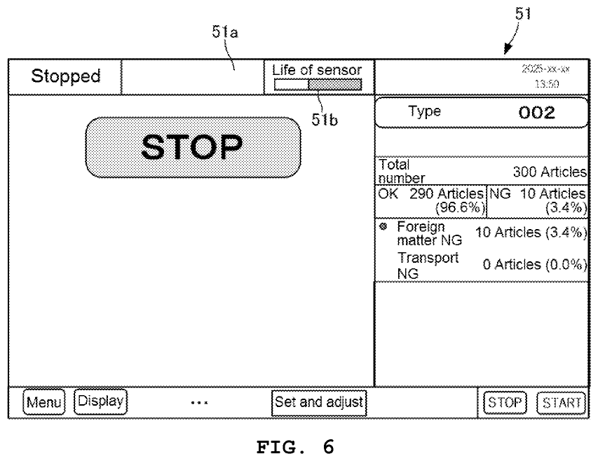

Then, when the signs of the performance deterioration of the X-ray detector 25 are detected, the control unit 33 can output an example of remaining life display 51b, which represents the remaining life of the X-ray detector 25 using a bar-graph-type icon known from battery level marks and the like, on the display screen of the display output means 41, for example, in a state display region 51a in an upper portion of a normal inspection screen 51 (default screen) as shown in FIG. 6.

In addition, the preventive maintenance control unit 33b of the control unit 33 can compare the alignment data items Dlx(t(i)) and Dlx(t(i−1)) during sensitivity correction before and after the predetermined deterioration observation period Txde corresponding to the operating environment of the manufacturing line or the like in which the X-ray inspection device 1 is installed, for example, before and after a deterioration observation period Txde of about a monthly inspection in a continuous operating environment or a deterioration observation period Txde of about a semi-annual inspection in a daytime operating environment, thereby accurately and timely detecting the signs of the performance deterioration of the X-ray detector 25 that significantly affects the inspection.

Further, in the present embodiment, the deterioration sign detection means P1 determines the sensitivity deterioration of the X-ray detector 25 based on the deviation between the past alignment data Dlx(t(i−1)) already stored in the sensitivity correction data storage unit 35 and the current or most recent alignment data Dlx(t(i)), and detects the signs of the performance deterioration of the X-ray detector 25 according to the determination result of the deterioration. Therefore, when the deviation between the past, for example, previous or initial alignment data Dlx(t(i−1)) and the current or most recent alignment data Dlx(t(i)) before and after the predetermined deterioration observation period Txde is large, it is possible to determine that there are signs of the performance deterioration of the X-ray detector 25 that significantly affects the inspection. When the deviation is not large, it is possible to determine that there are no signs of the performance deterioration of the X-ray detector 25 that significantly affects the inspection.

In addition, in the present embodiment, the X-ray inspection device 1 further includes the timer 36c that measures the cumulative irradiation time Txde of the X-ray irradiation unit 21 from the storage of the past alignment data Dlx(t(i−1)) in the sensitivity correction data storage unit 35 to the storage of the current or most recent alignment data Dlx(t(i)) and the deterioration rate calculation means P2 for calculating the performance deterioration rate of the X-ray detector 25 based on the deviation between the past alignment data Dlx(t(i−1)) and the current or most recent alignment data Dlx(t(i)) and the cumulative irradiation time Txde of the X-ray irradiation unit 21 when the deterioration sign detection means P1 detects the signs of the performance deterioration of the X-ray detector 25. Therefore, when the signs of the performance deterioration of the X-ray detector 25 are detected, the performance deterioration rate Vde of the X-ray detector 25 is calculated. Therefore, it is possible to accurately estimate the time when the probability of performance deterioration of the X-ray detector 25 is high according to the performance deterioration rate Vde with reference to the current or most recent sensitivity correction.

Further, in the present embodiment, the X-ray inspection device 1 further includes the effective available inspection time calculation means P3 for calculating the effective available inspection time Tei until the performance deterioration of the X-ray detector 25 that affects the inspection occurs, based on the performance deterioration rate Vde of the X-ray detector 25 calculated by the deterioration rate calculation means P2 and the current or most recent alignment data Dlx(t(i)), when the deterioration sign detection means P1 detects signs of the performance deterioration of the X-ray detector 25. Therefore, when the signs of the performance deterioration of the X-ray detector 25 are detected, it is possible to clearly understand the time until the probability of performance deterioration of the X-ray detector 25 is high as the effective available inspection time Tei.

Further, in the present embodiment, the reference converted alignment data obtained by multiplying the alignment data Dlx (t(i)) by the reference conversion coefficient Fc can be stored in the sensitivity correction data storage unit 35. Therefore, even when the inspection conditions can be changed due to, for example, the switching of the type of the inspection object during long-term use of the device, the alignment data Dlx is alignment data effective for deterioration determination considering a change in the tube voltage or tube current of the X-ray tube 22 in the X-ray irradiation unit 21, a change in the transport speed in the article transport unit 10, or the like. Therefore, it is possible to accurately calculate the performance deterioration rate of the X-ray detector 25 according to the actual situation of the user, regardless of the change in the inspection conditions due to the switching of the type of the inspection object or the like. As a result, the accuracy of preventive maintenance is improved.

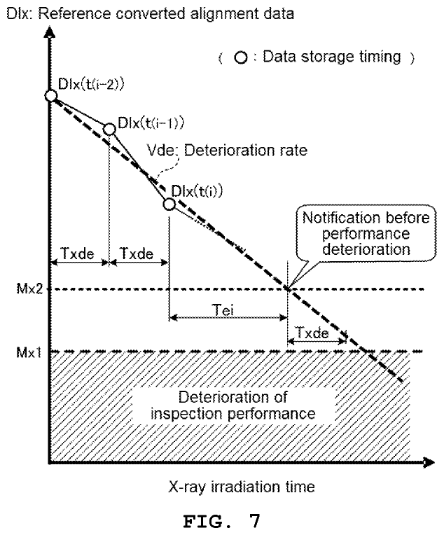

In addition, FIG. 7 shows that reference converted alignment data for a predetermined number of detection elements, which are located on both end sides of the X-ray detector 25 in the line scanning direction d2 and have the smallest belt surface detection brightness value, among the outputs of all of the detection elements e1 to eN of the X-ray detector 25 is stored as the alignment data Dlx in the sensitivity correction data storage unit 35 for each deterioration observation period Txde, a decrease rate Vde of an alignment data value is calculated as the performance deterioration rate per a predetermined number of deterioration observation periods Txde based on a predetermined number of most recent stored data items including the current data, for example, Dlx(t(i)), Dlx(t(i−1)), and Dlx(t(i−2)), the effective available inspection time Tei until the inspection performance reaches a notification request level Mx2, at which a time margin until the inspection performance is equal to or lower than a lower limit level Mx1 corresponding to the extent of reaching the service life (a hatched region in FIG. 7) has decreased to be longer than one deterioration observation period Txde and shorter than two deterioration observation periods Txde is calculated, and the effective available inspection time Tei is updated for each sensitivity correction timing, which makes it possible to appropriately and timely notify of the replacement time of the X-ray detector 25 due to the deterioration of the inspection performance.

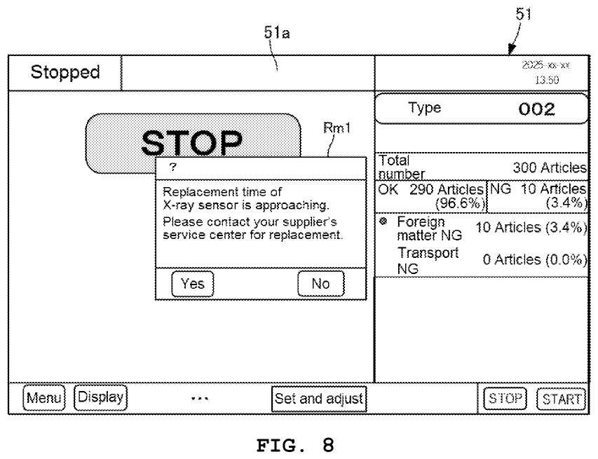

In addition, in the present embodiment, the X-ray inspection device 1 further includes the information output means P4 for outputting the screen information Rm1 and the audio information Rm2 shown in FIG. 1 and FIG. 8 indicating that the signs of the performance deterioration of the X-ray detector 25 have been detected during the period from the detection of the signs of the performance deterioration of the X-ray detector 25 by the deterioration sign detection means P1 to the lapse of the effective available inspection time Tei. Therefore, when the signs of the performance deterioration of the X-ray detector 25 have been detected, it is possible to accurately output information indicating this state to the user.

For example, as shown in FIG. 8, at the timing when the remaining life of the X-ray detector 25 is nearly exhausted, it is possible to notify that the replacement time of the X-ray detector 25 is approaching by means of the display information Rm1 displayed in the form of a pop-up on the normal inspection screen 51. Alternatively, for example, as shown in FIG. 9, at the timing when the remaining life of the X-ray detector 25 is nearly exhausted, it is possible to display text indicating that a replacement time alarm is being output in the state display region 51a in the upper portion of the normal inspection screen 51 while notifying that the replacement time of the X-ray detector 25 is approaching by means of an alarm.

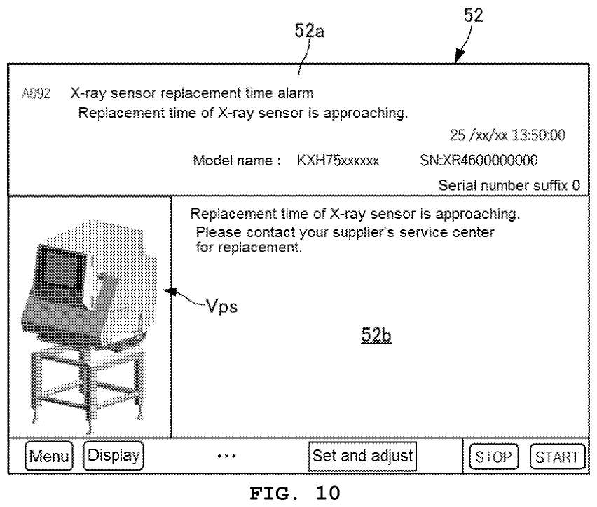

Further, for example, as shown in FIG. 10, at the timing when the remaining life of the X-ray detector 25 is nearly exhausted, first, the display information Rm1 displayed in the form of the pop-up on the normal inspection screen 51 shown in FIG. 8 is presented. When “Yes” is selected on the pop-up display screen, it is possible to display detailed information, such as the model type and serial number of the X-ray detector 25, in a display region 52a in an upper portion of a preventive maintenance screen 52 that opens in response to the selection, while notifying that the replacement time of the X-ray detector 25 is approaching by means of an alarm. For example, guidance for inquiry to the supplier's service center at the replacement time is displayed in a display region 52b in a lower portion of the preventive maintenance screen 52 together with an external perspective view Vps of the device indicating the alarm notification state.

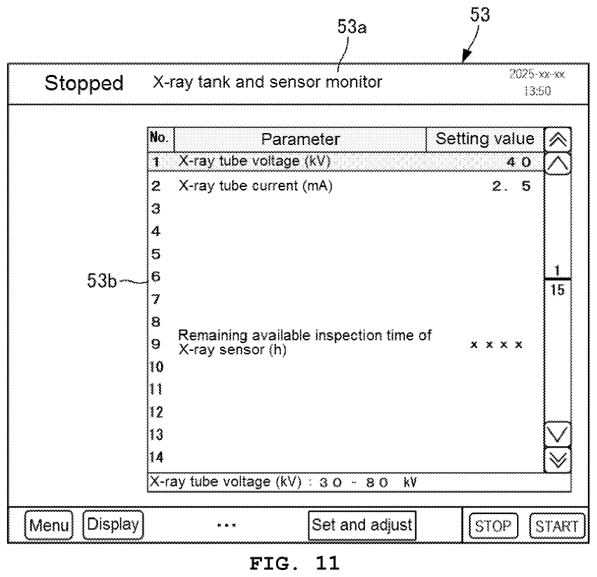

In addition, for example, as shown in FIG. 11, a hard status monitor screen 53 can be displayed on the display screen of the display output means 41, and a plurality of parameters and the like applied to the main components around the tank 23 of the X-ray irradiation unit 21 and the X-ray detector 25 can be displayed on the hard status monitor screen 53 together with the set values thereof and the like.

In the present embodiment, the information output means P4 is configured to display and output the decreased effective available inspection time Tei when the effective available inspection time Tei has decreased to a predetermined time. Therefore, when the signs of the performance deterioration of the X-ray detector 25 are detected and the effective available inspection time Tei has decreased to the predetermined time, the decreased effective available inspection time Tei is displayed and output, which makes it possible to timely output accurate preventive maintenance information to the user.

Further, when the performance deterioration rate Vde of the X-ray detector 25 is increased beyond a predetermined degree of temporal change, the information output means P4 may display and output the effective available inspection time Tei decreased in the accelerated manner and the degree of acceleration (deterioration).

In this case, it is possible to output more accurate preventive maintenance information to the user. Alternatively, when the calculated value of the effective available inspection time Tei is less than the lower limit remaining period Tr until the design life of the X-ray detector 25, the information output means P4 displays and outputs the effective available inspection time Tei. In this case, it is possible to rapidly output accurate preventive maintenance information to the user. Furthermore, when the calculated effective available inspection time Tei is already shorter than the lower limit remaining period Tr until the design life of the X-ray detector 25, the information output means P4 may display and output the effective available inspection time Tei. In this case, it is possible to timely and accurately output, to the user, information indicating that the probability of performance deterioration of the X-ray detector 25 which significantly affects the inspection is high and the arrival of the replacement time, from changes in the performance deterioration rate Vde and the effective available inspection time Tei of the X-ray detector 25.

As described above, according to the present embodiment, it is possible to provide the X-ray inspection device 1 that can accurately detect the performance deterioration of the X-ray detector 25 that significantly affects the inspection of the article in advance and perform effective preventive maintenance.

Further, in the above-described embodiment, the X-ray inspection device 1 in which the preventive maintenance control unit 33b is provided in the control unit 33 has been described. However, it is also considered that the sensitivity correction data storage unit 35 is provided in a plurality of X-ray inspection devices 1 that inspect the articles W, which are inspection objects of the same type, and a configuration corresponding to the preventive maintenance control unit 33b is independently provided as a preventive maintenance device that can be shared by the plurality of X-ray inspection devices 1. In this case, it is considered that the independent configuration portion corresponding to the preventive maintenance control unit 33b serving as the preventive maintenance device of each X-ray inspection device 1 can perform data communication with the sensitivity correction data storage unit 35 provided in any of the X-ray inspection devices 1 and includes the deterioration sign detection means P1 for comparing the alignment data during sensitivity correction before and after the cumulative irradiation time Txde, which is a predetermined deterioration observation period, to detect signs of the performance deterioration of the X-ray detector 25 that affects the inspection.

Even in this case, in the device according to the present invention, when the X-ray detector 25 is corrected to a suitable detection sensitivity, the alignment data is stored in the sensitivity correction data storage unit 35 before the sensitivity correction of the X-ray detector 25. Then, the alignment data items Dlx(t(i)) and Dlx(t(i−1)) during sensitivity correction stored in the sensitivity correction data storage unit 35 are compared before and after the predetermined deterioration observation period Txde. When significant performance deterioration of the X-ray detector 25 occurs during the deterioration observation period Txde, the deviation between the compared alignment data items is large, which makes it possible to accurately detect the signs of the performance deterioration of the X-ray detector 25 that affects the inspection.

In addition, the deterioration observation period is set according to the operating environment of the production line or the like in which the X-ray inspection device 1 is installed. For example, setting is performed to multiply the default deterioration observation period Txde by a correction coefficient (<1) that shortens the deterioration observation period in a high-temperature and high-humidity environment or by a correction coefficient (>1) that lengthens the deterioration observation period Txde when the article W is thick and the transport density thereof is high. Then, the alignment data during sensitivity correction before and after the deterioration observation period Txde is compared, which makes it possible to timely and accurately detect signs of the performance deterioration of the X-ray detector 25 that significantly affects the inspection.

Further, when the deviation between the alignment data items Dlx(t(i)) and Dlx(t(i−1)) before and after the predetermined deterioration observation period Txde is large, it can be determined that there are signs of the performance deterioration of the X-ray detector 25 that significantly affects the inspection. In addition, the performance deterioration rate Vde of the X-ray detector 25 is calculated when the signs of the performance deterioration of the X-ray detector 25 are detected. Therefore, it is possible to accurately estimate the time when the probability of performance deterioration of the X-ray detector 25 is high.

As described above, the present invention can provide an X-ray inspection device that can accurately detect performance deterioration of an X-ray detector that significantly affects the inspection of an article in advance and can perform effective preventive maintenance and a preventive maintenance device for the X-ray inspection device. The present invention is useful for all X-ray inspection devices having a preventive maintenance function.

### DESCRIPTION OF REFERENCE NUMERALS AND SIGNS

1 X-ray Inspection Device
10 Article Transport Unit
11 Transport Belt
11a Transport Path (Transport Path Surface)
12, 13 Roller
20 X-ray Imaging Unit
21 X-ray Irradiation Unit
22 X-ray Tube
22a Cathode
22b Anode
23 Tank
23a X-ray Window Portion
24 X-ray Detection Element Group (Plurality of X-ray Detection Elements)
24a Scintillator
24b Photodiode Array (Plurality of Light-Receiving Elements)
25a Detection Substrate
25 X-ray Detector
26 One Drive Power Supply Circuit
27 Other Drive Power Supply Circuit
29 Article Detection Sensor
30 Control Device
31 Transmission Image Generation Unit (Image Data Acquisition Unit)
32 Image Data Storage Unit
33 Control Unit
33a Inspection Control Unit
33b Preventive Maintenance Control Unit
34 Information Output Control Unit
35 Sensitivity Correction Data Storage Unit (Alignment Data Storage Unit)
36 Inspection Condition Setting Adjustment Unit
36a Setting Means
36b Adjustment Means
36c Timer (Time Measurement Means)
40 Information Input/Output Unit
41 Display Output Means
42 Operation Input Means
43 Notification Means
Ct0 High Transmittance State
d1 Transport Direction
d2 Line Scanning Direction
Dlx0 Output Data of X-ray Detection Element Group (Alignment Data in High Transmittance State)

Dlx1 Output Data of X-ray Detection Element Group (Alignment Data in Low Transmittance State)

Dlx2 Output Data of X-ray Detection Element Group (Alignment Data in Medium Transmittance State)

Dlxa0, Dlxa1, Dlxa2 Theoretical Output e1 to en Detection Element (Light-Receiving Element, n X-ray Detection Elements in Each Sensor Module)
F1 Image Processing Unit
F2 Inspection Determination Means
Lx0(i, j) Detection Element Output (Detection Element Output in High Transmittance State)
Lx1(i, j) Detection Element Output (Detection Element Output in Low Transmittance State)
Lx2(i, j) Detection Element Output (Detection Element Output in Medium Transmittance State)
Lxa(i, j) Theoretical Output
Lxa0(i, j), Lxa1(i, j), Lxa2(i, j) Correction Target Value
M1, M2, M3, Mi, Mi+1, Mk Sensor Module
P1 Deterioration Sign Detection Means
P2 Deterioration Rate Calculation Means (Deviation Calculation Means)
P3 Effective Available Inspection Time Calculation Means
P4 Information Output Means
Rm1 Screen Information
Rm2 Audio Information
Tei Effective Available Inspection Time
Tr Lower Limit Remaining Period (Remaining Time Until Design Life)
Txde Cumulative Irradiation Time (Deterioration Observation Period)
Va, Vc, Vb Correction Target Value
Vbs Maximum Detection Brightness
Vde Performance Deterioration Rate
W Article (Inspection Object)
Xb X-ray Beam

What is claimed is:

1. An X-ray inspection device comprising:
an X-ray irradiation unit that irradiates an article on a transport path surface with X-rays under predetermined irradiation conditions;
an X-ray detector that has a plurality of detection elements arranged parallel to the transport path surface and in a direction orthogonal to a transport direction of the article and that outputs an X-ray detection signal from each of the plurality of detection elements;
an inspection control unit that executes image processing for inspecting a quality state of the article based on the X-ray detection signals from the plurality of detection elements;
an alignment data storage unit that stores alignment data during sensitivity correction which corresponds to the arrangement of the plurality of detection elements for each predetermined period; and
deterioration sign detection means for comparing the alignment data during sensitivity correction before and after a predetermined deterioration observation period to detect a sign of performance deterioration of the X-ray detector which affects the inspection.

2. The X-ray inspection device according to claim 1,
wherein the deterioration sign detection means determines deterioration in sensitivity of the X-ray detector based on a deviation between past alignment data already stored in the alignment data storage unit and current or most recent alignment data, and detects the sign of the performance deterioration of the X-ray detector according to a determination result of the deterioration.

3. The X-ray inspection device according to claim 2, further comprising:
time measurement means for measuring an irradiation time of the X-ray irradiation unit or/and an elapsed time from storage of the past alignment data in the alignment data storage unit to storage of the current or most recent alignment data; and
deterioration rate calculation means for calculating a performance deterioration rate of the X-ray detector, based on the deviation between the past alignment data and the current or most recent alignment data and the irradiation time of the X-ray irradiation unit or/and the elapsed time, when the deterioration sign detection means has detected the sign of the performance deterioration of the X-ray detector.

4. The X-ray inspection device according to claim 3, further comprising:
effective available inspection time calculation means for calculating an effective available inspection time until the performance deterioration of the X-ray detector which affects the inspection occurs, based on the performance deterioration rate of the X-ray detector calculated by the deterioration rate calculation means and the current or most recent alignment data, when the deterioration sign detection means has detected the sign of the performance deterioration of the X-ray detector.

5. The X-ray inspection device according to claim 4, further comprising:
information output means for outputting information indicating that the sign of the performance deterioration of the X-ray detector has been detected during a period from the detection of the sign of the performance deterioration of the X-ray detector by the deterioration sign detection means to a lapse of the effective available inspection time.

6. The X-ray inspection device according to claim 5,
wherein, when the effective available inspection time is decreased to a predetermined time, the information output means displays and outputs the decreased effective available inspection time.

7. The X-ray inspection device according to claim 5,
wherein, when the performance deterioration rate of the X-ray detector is increased beyond a predetermined degree of temporal change, the information output means displays and outputs the effective available inspection time decreased in an accelerated manner.

8. The X-ray inspection device according to claim 5,
wherein, when a calculated value of the effective available inspection time is less than a remaining period until a design life of the X-ray detector, the information output means displays and outputs the effective available inspection time.

9. The X-ray inspection device according to claim 5,
wherein, when the calculated effective available inspection time is shorter than a remaining period until a design life of the X-ray detector, the information output means displays and outputs the effective available inspection time.

10. The X-ray inspection device according to claim 1,
wherein the alignment data is stored in the alignment data storage unit as data converted into reference converted alignment data which is an index of performance of the X-ray detector.

11. The X-ray inspection device according to claim 2,
wherein the alignment data is stored in the alignment data storage unit as data converted into reference converted alignment data which is an index of performance of the X-ray detector.

12. The X-ray inspection device according to claim 3,
wherein the alignment data is stored in the alignment data storage unit as data converted into reference converted alignment data which is an index of performance of the X-ray detector.

13. The X-ray inspection device according to claim 4,
wherein the alignment data is stored in the alignment data storage unit as data converted into reference converted alignment data which is an index of performance of the X-ray detector.

14. The X-ray inspection device according to claim 5,
wherein the alignment data is stored in the alignment data storage unit as data converted into reference converted alignment data which is an index of performance of the X-ray detector.

15. The X-ray inspection device according to claim 6,
wherein the alignment data is stored in the alignment data storage unit as data converted into reference converted alignment data which is an index of performance of the X-ray detector.

16. The X-ray inspection device according to claim 7,
wherein the alignment data is stored in the alignment data storage unit as data converted into reference converted alignment data which is an index of performance of the X-ray detector.

17. The X-ray inspection device according to claim 8,
wherein the alignment data is stored in the alignment data storage unit as data converted into reference converted alignment data which is an index of performance of the X-ray detector.

18. The X-ray inspection device according to claim 9,
wherein the alignment data is stored in the alignment data storage unit as data converted into reference converted alignment data which is an index of performance of the X-ray detector.

19. A preventive maintenance device for an X-ray inspection device, the preventive maintenance device performing preventive maintenance of the X-ray inspection device including an X-ray irradiation unit that irradiates an article on a transport path surface with X-rays under predetermined irradiation conditions, an X-ray detector that has a plurality of detection elements arranged parallel to the transport path surface and in a direction orthogonal to a transport direction of the article and that outputs an X-ray detection signal from each of the plurality of detection elements, and an inspection control unit that executes image processing for inspecting a quality state of the article based on the X-ray detection signals from the plurality of detection elements, the preventive maintenance device comprising:
an alignment data storage unit that stores alignment data during sensitivity correction which corresponds to the arrangement of the plurality of detection elements for each predetermined period; and
deterioration sign detection means for comparing the alignment data during sensitivity correction before and after a predetermined deterioration observation period to detect a sign of performance deterioration of the X-ray detector which affects the inspection.
